(19) United States
(12) Patent Application Publication
(10) Pub. No.: US 2013/0240184 A1
(43) Pub. Date: Sep. 19, 2013

(54) HEAT DISSIPATION STRUCTURE OF A LIGHTING ENGINE, A MANUFACTURING METHOD THEREOF AND A LIGHTING SYSTEM COMPRISING THE STRUCTURE

(71) Applicants: Chenglong Dai, Shenzhen (CN); Nimchung Ku, Shenzhen (CN); Canbang Yang, Shenzhen (CN); Haiping Yuan, Shenzhen (CN)

(72) Inventors: Chenglong Dai, Shenzhen (CN); Nimchung Ku, Shenzhen (CN); Canbang Yang, Shenzhen (CN); Haiping Yuan, Shenzhen (CN)

(73) Assignee: OSRAM GmbH, Muenchen (DE)

(21) Appl. No.: 13/989,825

(22) PCT Filed: Nov. 8, 2011
(86) PCT No.: PCT/EP2011/069620

§ 371 Date: May 28, 2013

(30) Foreign Application Priority Data
Nov. 29, 2010 (CN) 201010565247.X

(51) Int. Cl. F21V 29/00; F28F 21/08; B21D 53/02; F28F 19/02

(52) U.S. Cl. CPC F21V 29/22; F28F 19/02; F28F 21/089; B21D 53/02
USPC 165/134.1; 165/185; 29/890.03

(57) ABSTRACT

A heat dissipation structure for a lighting engine, may include: a primary heat sink, and an extended heat sink, wherein the primary heat sink has a first contact surface, and the extended heat sink has a second contact surface provided opposite to the first contact surface, the first contact surface and the second contact surface directly contacted each other with no additional layer therebetween.

### RELATED APPLICATIONS

The present application is a national stage entry according to 35 U.S.C. §371 of PCT application No.: PCT/EP2011/069620 filed on Nov. 8, 2011, which claims priority from Chinese application No.: 201010565247.X filed on Nov. 29, 2010.

### TECHNICAL FIELD

Various embodiments relates to a heat dissipation structure, in particular, to a heat dissipation structure of a lighting engine.

### BACKGROUND

The problem of heat dissipation of the lighting engine is an important problem deserving attention. The heat dissipation structure of the lighting engine usually comprises two parts: one is a compatible heat sink for the lighting engine, i.e. primary heat sink, and the other is an extended heat sink added according to the light source power of the lighting engine. In the prior art, the primary heat sink and the extended heat sink are connected by the thermal material interface, such as heat dissipation grease, thermal glue, thermal pad, etc. However, the thermal material interface in the prior art will increase unnecessary thermal resistance.

### SUMMARY

Various embodiments provide a heat dissipation structure of the lighting engine in which the thermal resistance between the primary heat sink and the extended heat sink is minimized. The heat dissipation structure not only has the advantage of low thermal resistance, but also has the advantages of simple structure, easy assembling and low cost.

Various embodiments includes the following solution: a heat dissipation structure for a lighting engine, comprising: a primary heat sink, and an extended heat sink, wherein the primary heat sink has a first contact surface, and the extended heat sink has a second contact surface provided opposite to the first contact surface, the first contact surface and the second contact surface directly contacted each other with no additional layer therebetween. By performing heat dissipation in the manner of thermal conducting by ensuring direct and sufficient contact between the first contact surface and the second contact surface, various embodiments avoid the problem of thermal resistance increase caused by the interface thermal material between the first contact surface and the second contact surface. In various embodiments, the interface thermal material layer is not needed, instead, the emphasis is particularly put on improving the first contact surface and the second contact surface themselves to reduce the thermal resistance, “contact surfaces” in various embodiments is considered to be any area of the heat sink of macrocopical dimensions, typically at least in the range of millimeters, where the primary heat sink and the extended heat sink direct contact with each other.

According to various embodiments, the first contact surface and the second contact surface are designed to be smooth with a predefined smoothness. Preferably, the predefined smoothness is determined by a desired thermal resistance therebetween and manufacturing conditions. The specific value of the smoothness is a compatible result of the desired thermal resistance and the manufacturing conditions. The preferred solution provides a reliable solution for improving the contact surfaces themselves. The smooth surfaces obtained by machining, for instance, such as polishing, can ensure the reliable contact between the first contact surface and the second contact surface, which enables the microcosmic particles included in the interface to well contact each other. Preferably, the roughness Ra of the first contact surface and the second contact surface is <=0.8 μm.

According to various embodiments, the first contact surface and the second contact surface are to be flat with a predefined flatness. Preferably, the predefined flatness is determined by a desired thermal resistance therebetween and manufacturing conditions. Preferably, the flatness of the flat surfaces is <=0.05mm. It should be noted that the first contact surface and the second contact surface can alternatively to be not flat, but fit each other with other suitable contour. According to a further improved technical solution of various embodiments, the first contact surface and the second contact surface are sprayed with an anti-oxidation material. Therefore, good contact between the two contact surfaces in a long term is ensured by preventing oxidation.

According to a further embodiment, the first contact surface and the second contact surface are connected together by a mechanical fastening structure. Preferably, the fastening structure includes fastening holes provided on each contact surface and fastening members passing through the fastening holes.

Various embodiments further relate to a lighting system comprising the heat dissipation structure having the above features.

Various embodiments further relates to a manufacturing method of a heat dissipation structure of a lighting engine, characterized by including the following steps: a) providing a primary heat sink having a first contact surface and an extended heat sink having a second contact surface; and b) machining the first contact surface and the second contact surface and then the first contact surface and the second contact surface directly contacted each other with no additional layer therebetween.

A further improved solution of the method according to various embodiments further includes step c) after step a): coating an anti-oxidation layer on the first contact surface and the second contact surface.

A further improved solution of the method according to various embodiments further includes: step d) after step b) or c): fixing the primary heat sink and the extended heat sink together using the fastening members and the fastening holes provided on the first contact surface and the second contact surface.

According to a further improved solution of the method according to various embodiments, in step b), the first contact surface and the second contact surface are machined into smooth surfaces and flat surfaces with a predefined smoothness and a predefined flatness. The predefined smoothness and the predefined flatness are determined by a desired thermal resistance therebetween and manufacturing conditions. The preferred roughness Ra<=0.8 μm. Further preferably, each contact surface is machined into flat surface with a preferred flatness<=0.05 mm.

The heat dissipation structure and lighting system according to various embodiments minimize the thermal resistance between the primary heat sink and the extended heat sink and have the advantages of low thermal resistance and simple structure.

### BRIEF DESCRIPTION OF THE DRAWINGS

In the drawings, like reference characters generally refer to the same parts throughout the different views. The drawings are not necessarily to scale, emphasis instead generally being replaced upon illustrating the principles of the disclosed embodiments. In the following description, various embodiments are described with reference to the following drawings, in which:

FIG. 1 shows the first example of the heat dissipation structure according to the disclosed embodiments;

FIG. 2 shows the second example of the heat dissipation structure according to the disclosed embodiments; and

FIG. 3 is a flow chart of one example of the manufacturing method of the heat dissipation structure according to the disclosed embodiments.

### DETAILED DESCRIPTION

The following detailed description refers to the accompanying drawing that show, by way of illustration, specific details and embodiments in which the disclosed embodiments may be practiced.

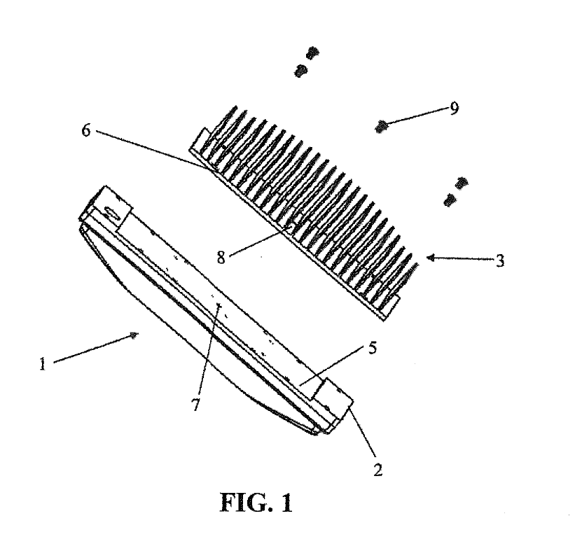

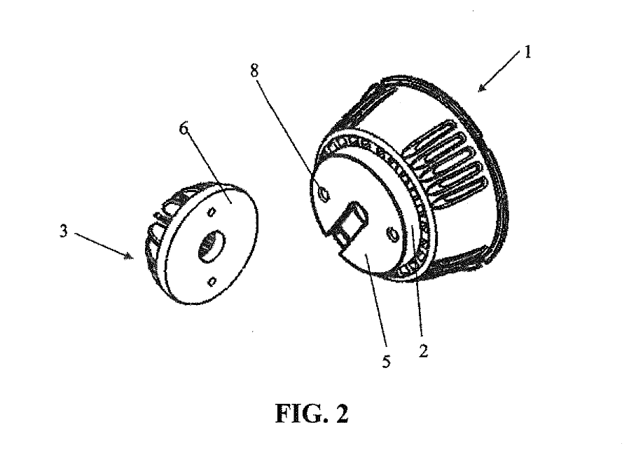

FIG. 1 and FIG. 2 show the first and second examples of the heat dissipation structure according to various embodiments, respectively. The difference between the first example and the second example lies in the different designs of the primary heat sink and the extended heat sink.

Next, various embodiments will be illustrated in detail with reference to the first example.

As shown in FIG. 1, the primary heat sink 2 is a compatible heat sink designed for various product models. In FIG. 1, the compatible heat sink is the portion of the surrounding environment directly contacting the lighting engine structure 1. The primary heat sink 2 directly neighbors the light source (not shown, located within the lighting engine structure as the thermal source.) The additional heat sink 3 is designed to match powers of different lighting engine structures 1.

The improvement of various embodiments lies in the connection between the primary heat sink 2 and the addition heat sink 3. From the figure it can be seen that the primary heat sink 2 has a first contact surface 5, and the additional heat sink 3 has a second contact surface 6. The contact between the two contact surfaces according to various embodiments is a direct contact. That is to say, the additional thermal material layer provided between the two contact surfaces in the prior art is not needed. Good thermal conductivity of such direct contact, i.e. low thermal resistance, is realized by designing the two contact surfaces 5 and 6 themselves. Specifically, it is realized by machining the two contact surfaces 5 and 6 in this example. Preferably, they can be machined into two contact surfaces smooth enough, and the smooth degree should guarantee the thermal diffusion between the two contact surfaces so as to achieve a thermal resistance as low as possible. Alternatively or further, the two contact surfaces are designed to be flat and the flatness is adjusted to ensure the thermal resistance between the two to be as low as possible. The optimal roughness value of the first and second contact surfaces 5 and 6 Ra is <=0.8 μm, and the optimal flatness value of the first and second contact surfaces 5 and 6 is <=0.05 mm. In this preferred example, an anti-oxidation material is further sprayed on the first and second contact surfaces 5 and 6. The anti-oxidation material mainly functions to prevent oxidation that makes it hard for the two contact surfaces 5 and 6 to realize good contact in a long term. In the situation that the two contact surfaces 5 and 6 are designed to be smooth, the fixation between the two is realized by a mechanical fastening structure. The mechanical fastening structure in the present example includes the fastening holes 7 and 8 provided on the contact surfaces 5 and 6, respectively, and the fastening members 9 passing through the fastening holes 7 and 8. The fastening member 9 is, for instance, screw, bolt, etc.

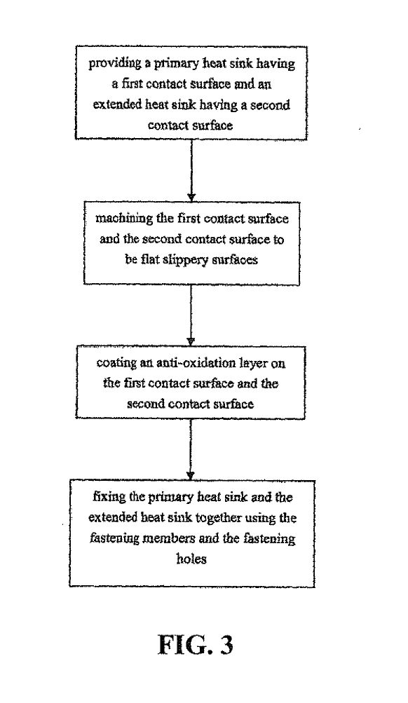

FIG. 3 is a flow chart of one example of a manufacturing method of a heat dissipation structure according to the embodiment. The manufacturing method includes the following steps: a) providing a primary heat sink having a first contact surface and an extended heat sink having a second contact surface; b) machining the first contact surface and the second contact surface to enable the first contact surface and the second contact surface to directly thermally contact, wherein in step b), the first contact surface and the second contact surface are machined into flat smooth surfaces; c) after step b), coating an anti-oxidation layer on the first contact surface and the second contact surface; and d) after step b) or c), fixing the primary heat sink and the extended heat sink together using the fastening members and the fastening holes provided on the first contact surface and the second contact surface.

While the disclosed embodiments have been particularly shown and described with reference to specific embodiments, it should be understood by those skilled in the art that various change in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

### LIST OF REFERENCE SIGNS

1 lighting engine

2 primary heat sink

3 extended heat sink

5 first contact surface

6 second contact surface

7, 8 fastening hole

9 fastening member

1. A heat dissipation structure for a lighting engine, comprising: a primary heat sink, and an extended heat sink, wherein the primary heat sink has a first contact surface, and the extended heat sink has a second contact surface provided opposite to the first contact surface, the first contact surface and the second contact surface directly contacted each other with no additional layer therebetween.

2. The heat dissipation structure according to claim 1, wherein the first contact surface and the second contact surface are smooth with a predefined smoothness.

3. The heat dissipation structure according to claim 1, wherein the first contact surface and the second contact surface are flat with a predefined flatness.

4. The heat dissipation structure according to claim 2, wherein the predefined smoothness is determined by a desired thermal resistance therebetween and manufacturing conditions.

5. The heat dissipation structure according to claim 4, wherein roughness of the first contact surface and the second contact surface is <=0.8 μm.

6. The heat dissipation structure according to claim 16, wherein the flatness of the flat surfaces is <=0.05 mm.

7. The heat dissipation structure according to claim 1, wherein the first contact surface and the second contact surface are sprayed with an anti-oxidation material.

8. The heat dissipation structure according to claim 1, wherein the first contact surface and the second contact surface are connected together by a mechanical fastening structure.

9. The heat dissipation structure according to claim 8, wherein the fastening structure includes fastening holes provided on the first contact surface and the second contact surface and fastening members passing through the fastening holes.

10. A lighting system comprising a heat dissipation structure for a lighting engine, the heat dissipation structure comprising: a primary heat sink, and an extended heat sink, wherein the primary heat sink has a first contact surface, and the extended heat sink has a second contact surface provided opposite to the first contact surface, the first contact surface and the second contact surface directly contacted each other with no additional layer therebetween.

11. A manufacturing method of a heat dissipation structure of a lighting engine, the method comprising: a) providing a primary heat sink having a first contact surface and an extended heat sink having a second contact surface; and b) machining the first contact surface and the second contact surface and then the first contact surface and the second contact surface directly contact each other with no additional layer therebetween.

12. The method according to claim 11, the method further comprising, c) after a): coating an anti-oxidation layer on the first contact surface and the second contact surface.

13. The method according to claim 11, the method further comprising d) after b): fixing the primary heat sink and the extended heat sink together using the fastening members and the fastening holes provided on the first contact surface and the second contact surface.

14. The method according to claim 11, wherein in b), the first contact surface and the second contact surface are machined into smooth surfaces and flat surfaces with a predefined smoothness and a predefined flatness.

15. The method according to claim 14, wherein in b), the predefined smoothness and the predefined flatness are determined by a desired thermal resistance therebetween and manufacturing conditions.

16. The heat dissipation structure according to claim 3, wherein the predefined flatness is determined by a desired thermal resistance therebetween and manufacturing conditions.

17. The method according to claim 12, the method further comprising, d) after c): fixing the primary heat sink and the extended heat sink together using the fastening members and the fastening holes provided on the first contact surface and the second contact surface.
